(19) United States
(12) Patent Application Publication
(10) Pub. No.: US 2008/0217094 A1
(43) Pub. Date: Sep. 11, 2008

(54) Bearing for a rack and pinion steering apparatus

(76) Inventor: John Crossman, Rockwood, MI (US)

Correspondence Address: AUTOMOTIVE COMPONENTS HOLDINGS LLC;C/O MACMILLAN, SOBANSKI & TODD, LLC, ONE MARITIME PLAZA, FIFTH FLOOR, 720 WATER STREET, TOLEDO, OH, 43604-1853, US

(21) Appl. No.: 11/714,568

(22) Filed: Mar. 6, 2007

(51) Int. Cl. B62D 5/22

(52) U.S. Cl. 180/428

(57) ABSTRACT

A rack and pinion steering system includes a pinion having an upper shaft section, a gear section, and a lower shaft section, wherein the gear section is located between the upper shaft section and the lower shaft section. A rack is included that has a gear section for coupling with the gear section of the pinion. A housing encloses at least portions of the pinion and the rack. A bearing is rotatably received within the housing and has an inner surface for supporting the lower shaft section of the pinion. The inner surface of the bearing has a Gothic-arch shaped cross-section for reducing rattle sensitivity to alternating sinusoidal loads between the bearing and the pinion.

### BACKGROUND OF THE INVENTION

1. Field of the Invention

The present invention relates generally to a rack and pinion steering assembly; and more specifically, to a bearing for a rack and pinion of the steering assembly.

2. Description of Related Art

Modern automotive vehicle steering assemblies typically use a rack and pinion gear system that translates the rotational movement of the steering wheel into linear movement needed to turn the vehicle wheels. In general, a housing encloses a rack and pinion gear set. A steering shaft extends partially into the housing with a first end connectable to the steering wheel. A second end of the steering shaft is connected with the pinion gear. The pinion gear is meshingly engaged with the rack such that rotation of the steering wheel turns the pinion gear which then correspondingly moves the rack. The pinion gear is typically rotatably supported with respect to the rack gear by one or more bearings. The rack is then connected to the vehicle wheels via tie rods such that movement of the rack turns the wheels.

In manual steering gears, the lack of hydraulic damping forces sinusoidal steering loads from the rack into the pinion. The pinion is typically supported by bearings consisting of an upper ball bearing and a lower needle bearing. In this arrangement, the sinusoidal road loads cause the pinion to bounce back and forth inside the lower needle bearing causing a rattle. One known design to reduce this noise is to preload the bearing with a yoke spring and minimize the lower needle bearing diameteral clearance. However, such tight tolerance involves expensive machining which in turn increases the cost of the steering system and also leads to excessive gear assembly friction.

Thus, it is desirable to have a pinion gear support structure that minimizes lateral movement between the pinion gear shaft and the bearing that is effective and doesn't add cost to the steering system.

### SUMMARY OF THE INVENTION

Accordingly, the present invention is a rack and pinion steering system including a pinion having an upper shaft section, a gear section, and a lower shaft section, wherein the gear section is located between the upper shaft section and the lower shaft section of the pinion. A rack is included that has a gear section for coupling with the gear section of the pinion. A housing encloses at least portions of the pinion and the rack. A bearing is rotatably received within the housing and has an inner surface for supporting the lower shaft section of the pinion. The inner surface of the bearing has a Gothic arch shaped cross-section for eliminating alternating sinusoidal loads between the bearing and the pinion.

### BRIEF DESCRIPTION OF THE DRAWINGS

FIG. 1 is an exploded view of the rack and pinion steering system including the bearing according to the preferred embodiment of the present invention; and

FIG. 2 is a top view of the bearing according to the preferred embodiment of the present invention.

### DETAILED DESCRIPTION OF THE PREFERRED EMBODIMENTS

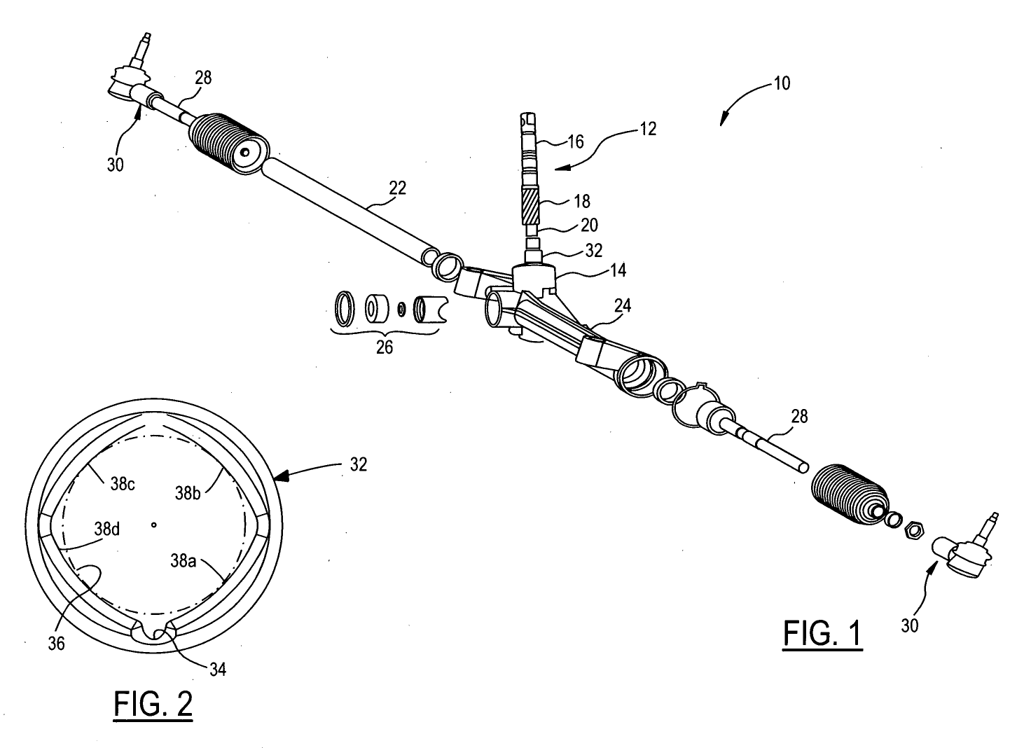

FIG. 1 shows an exploded view of a rack and pinion steering system, seen generally at 10, according to the preferred embodiment of the present invention. The rack and pinion steering system 10 includes a pinion 12 rotatably supported in a housing 14. The pinion 12 includes an upper shaft section 16, a gear section 18 and a lower shaft section 20. The upper shaft section attaches the pinion gear 18 to a steering wheel (not shown).

A rack 22 is supported in a rack housing 24 via a yoke assembly 26. The rack 22 is connected at each end to a tie rod 28. Each of the tie rods 28 are connected to tie rod ends 30 which are in turn connected to wheels (not shown). The rack 22 meshes with the pinion gear section 18 such that rotational movement of the steering wheel turns the vehicle wheels in a manner well known in the art.

The lower shaft section 20 is received by a lower bearing 32 for limiting lateral movement of the pinion 12. In the known prior art, the lower bearing 32 is typically a needle roller bearing, a round bushing, or a ball bearing having a circular inner surface. In all of these instances, the lower bearing 32 is typically subjected to alternating sinusoidal loads due to unwanted lateral movement of the pinion 12. The lower bearing 32 of the present invention, however, has a Gothic arch shaped cross-section on its inner surface.

Turning now to FIG. 2, there is shown a top view of the lower bearing 32 of the present invention illustrating more clearly the Gothic arch shaped cross-section of the inner surface 36. Rather than a true circular cross-section, a Gothic arch shape comprises four independent curved surfaces 38a, 38b, 38c, 38d, connected in a circular pattern. However, the curved surfaces 38a, 38b, 38c, 38d are minimal. Preferably, the Gothic arch provides approximately 0.2 mm of deviation from a true round, or circular, cross section. When subjected to alternating sinusoidal loads, forces on the bearing 32 alternate from one side of the inner surface, e.g., 38a, to the other side, e.g., 38d. This occurs without movement of the pinion 12, which is typical in a traditional circular inner surface cross-section, thereby allowing the bearing 32 to be insensitive to sinusoidal loads.

In the preferred embodiment, the lower bearing 32 also includes a notch 34 formed in the inner surface 36 of the bearing 32 for orienting the pinion 12. The forces between the rack 22 and the pinion 12 push the pinion 12 out normal to the rack 22. By aligning the notch 34 toward the yoke assembly 26, the rack 22 and pinion 12 separating forces are evenly distributed between two opposing curved surfaces, e.g., 38a to 38d. This balance allows the force to shift from one curved surface, e.g., 38a, to the other, e.g., 38d, when subjected to sinusoidal loads.

Thus, a Gothic arch lower bearing 32 provides stable support of the pinion 12 and is insensitive to sinusoidal rack loads. It doesn't require extremely tight tolerances and works with a significantly lower yoke preload. The description of the present invention is merely exemplary in nature and, thus, variations that do not depart from the gist of the invention are intended to be within the scope of the invention. Such variations are not to be regarded as a departure from the spirit and scope of the invention.

What is claimed is:

1. A rack and pinion steering system comprising:
a pinion having an upper shaft section, a gear section, and a lower shaft section, the gear section being located between the upper shaft section and the lower shaft section;
a rack having a gear section coupled with the gear section of the pinion;
a housing enclosing at least portions of the pinion and the rack; and
a bearing rotatably received within the housing and having an inner surface and an outer surface, the inner surface for supporting the lower shaft section of the pinion and having a Gothic arch shaped cross-section.

2. A rack and pinion steering system as set forth in claim 1 wherein the Gothic arch comprises of four independent curved surfaces connected in a circular pattern.

3. A rack and pinion steering system as set forth in claim 1 wherein the Gothic arch of the inner surface deviates from a true circular cross-section by approximately 0.2 mm.

4. A rack and pinion steering system as set forth in claim 1 wherein the bearing further includes a notch formed in the inner surface thereof for positioning the bearing in the housing.

5. A rack and pinion steering system comprising:
a pinion having an upper shaft section, a gear section, and a lower shaft section, the gear section being located between the upper shaft section and the lower shaft section;
a rack having a gear section coupled with the gear section of the pinion;
a housing enclosing at least portions of the pinion and the rack; and
a bearing rotatably received within the housing and having an inner surface and an outer surface, the inner surface for supporting the lower shaft section of the pinion and having a Gothic arch shaped cross-section consisting of four independent curved surfaces connected in a circular pattern.

6. A rack and pinion steering system as set forth in claim 5 wherein the Gothic arch of the inner surface deviates from a true circular cross-section by approximately 0.2 mm.

7. A rack and pinion steering system as set forth in claim 5 wherein the bearing further includes a notch formed in the inner surface thereof between two of the four independent curved surfaces for positioning the bearing in the housing.
